(19) United States
(12) Patent Application Publication
(10) Pub. No.: US 2025/0319584 A1
(43) Pub. Date: Oct. 16, 2025

(54) TOOLBOX FOR THE STORAGE OF VARIOUS TOOLS

(71) Applicant: Hong Ann Tool Industries Co., Ltd., Taichung City (TW)

(72) Inventor: Cheng-Wei SU, Taichung City (TW)

(21) Appl. No.: 18/634,475

(22) Filed: Apr. 12, 2024

(51) Int. Cl. B25H 3/02

(52) U.S. Cl. CPC B25H 3/022

(57) ABSTRACT

A toolbox for the storage of various tools comprising a container and a cover. The container is provided with a ratchet tool slot sequentially having a head section, a first wide section, and a first narrow section. The head section has a first width. The first wide section is provided with two first wide section protrusions, each protruding from different sides of an inner periphery of the first wide section, and a distance between the two first wide section protrusions has a second width, which is smaller than the first width. The first narrow section is provided with two first narrow section protrusions, each protruding from different sides of an inner periphery of the first narrow section, and a distance between the first narrow section protrusions has a third width, which is smaller than the second width.

### BACKGROUND OF THE INVENTION

The present invention relates to a toolbox and, more particularly, to a toolbox for the storage of various tools.

A toolbox can be used to carry multiple tools simultaneously and minimize tool loss. It can also be used to store work materials and hold items such as bolts, screws, and driving tools. In order to prevent tools from moving around and colliding inside the toolbox, they are frequently placed in sections with predetermined-shaped grooves. Nevertheless, this type of container can only hold tools or items with corresponding shapes. Users cannot change the holding spaces of the toolbox to fit their own requirements.

The present invention is, therefore, intended to obviate or at least alleviate the problems encountered in the prior art.

### SUMMARY OF THE INVENTION

A toolbox for the storage of various tools comprising a container and a cover configured to selectively open and close the container. The container is provided with a ratchet tool slot sequentially having a head section, a first wide section, and a first narrow section along the first reference line. A width direction of the ratchet tool slot is transverse to the first reference line and the head section has a first width. The first wide section is provided with two first wide section protrusions, each protruding from different sides of an inner periphery of the first wide section, and a distance between the two first wide section protrusions has a second width, which is smaller than the first width. The first narrow section is provided with two first narrow section protrusions, each protruding from different sides of an inner periphery of the first narrow section, and a distance between the first narrow section protrusions has a third width, which is smaller than the second width.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the concept upon which this disclosure is based may readily be utilized as a basis for designing other structures, methods, and systems for carrying out the several purposes of the present invention. It is important, therefore, that the claims be regarded as including such equivalent constructions insofar as they do not deviate from the spirit and scope of the present invention.

Furthermore, the purpose of the abstract is to enable the general public, particularly scientists, engineers, and practitioners in the field who may not be familiar with patent or legal terminology, to quickly determine the nature and essence of the technical information through a brief examination. The abstract is not meant to define the invention, which is determined by the claims, nor is it intended to limit the scope of the invention in any manner.

Other objectives, advantages, and new features of the present invention will become apparent from the following detailed description of the invention when considered in conjunction with the accompanied drawings.

### BRIEF DESCRIPTION OF DRAWINGS

FIG. 1 is a perspective view of a toolbox for the storage of various tools according to the present invention.

FIG. 2 is a plan view of FIG. 1.

FIG. 3 is a perspective view showing the toolbox of FIG. 1 being used to store various tools.

FIG. 4 is a plan view of FIG. 3.

FIG. 5 is a cross-sectional view taken along line 5-5 of FIG. 4.

FIG. 6 is a cross-sectional view taken along line 6-6 of FIG. 4.

FIG. 7 is a perspective view showing the toolbox of FIG. 1 being used to store a different set of tools from that in FIG. 3.

FIG. 8 is a plan view of FIG. 7.

### DETAILED DESCRIPTION OF THE INVENTION

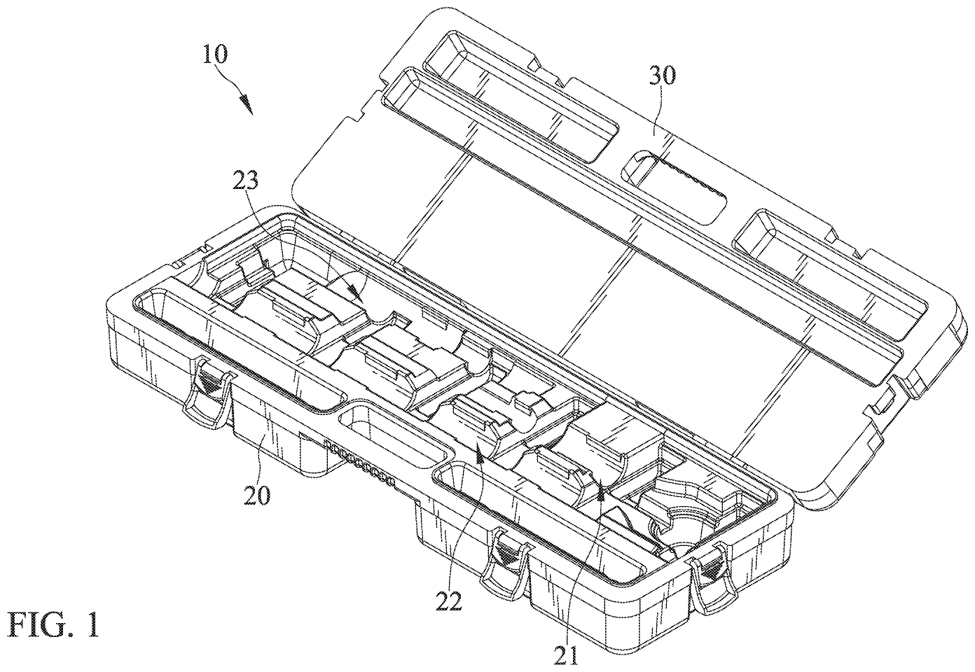

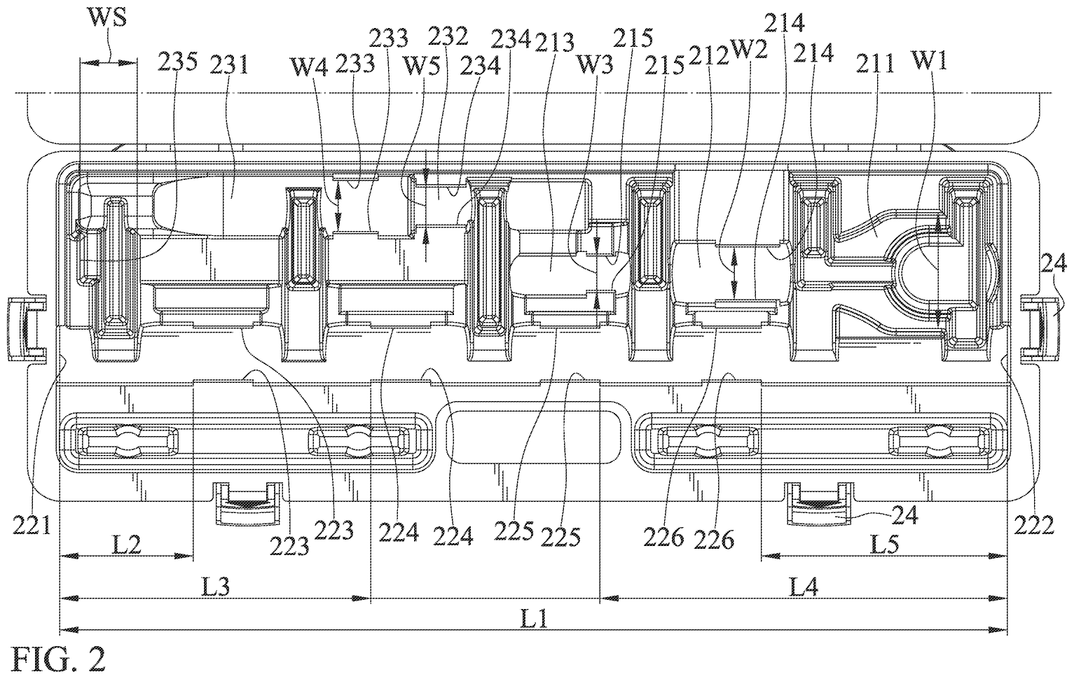

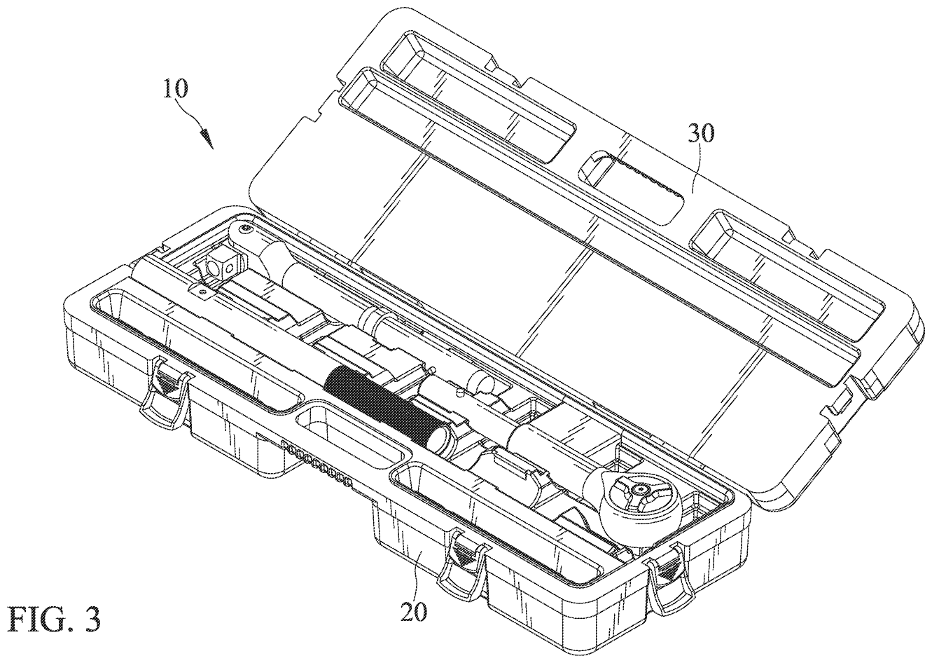

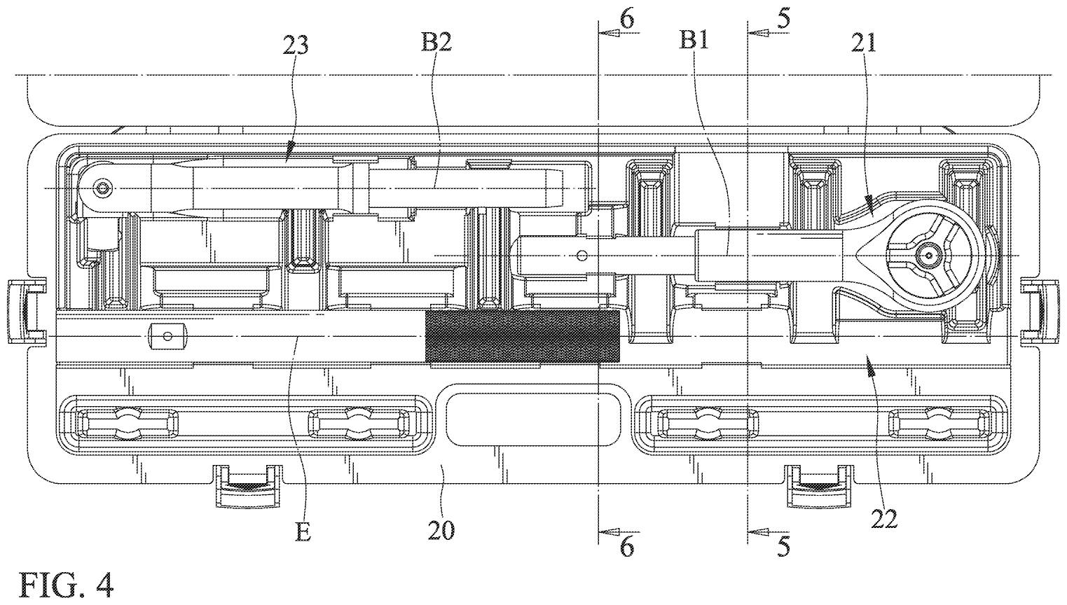

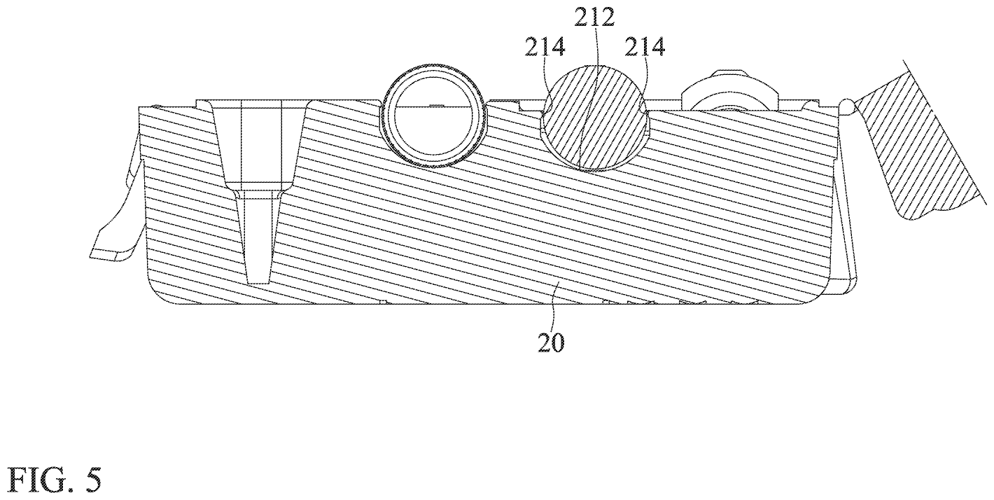

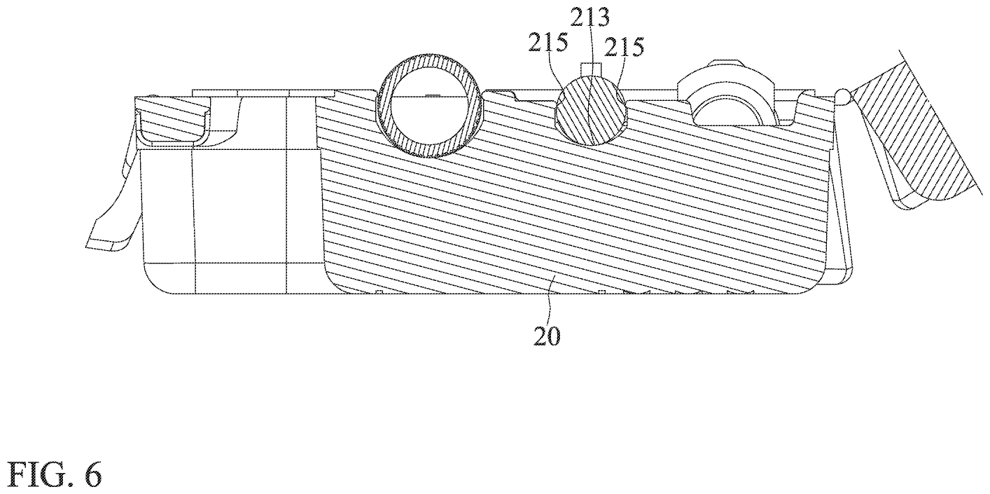

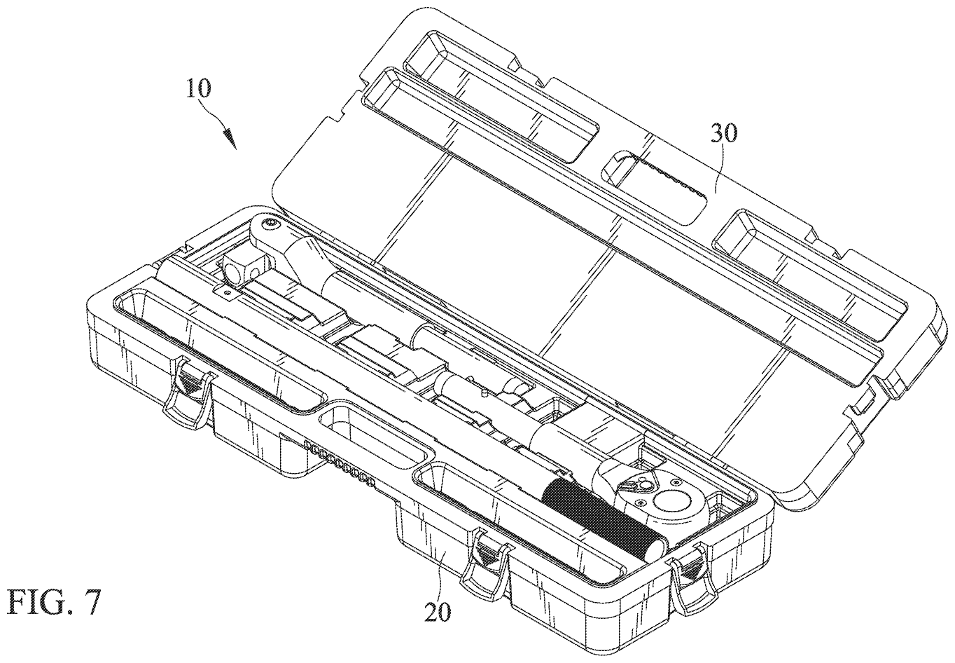

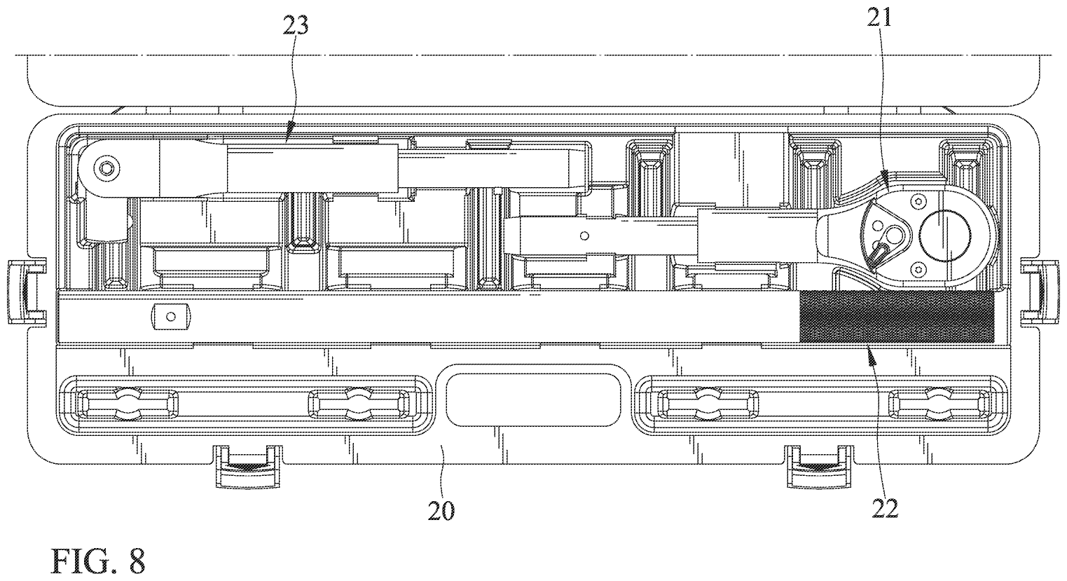

FIGS. 1-8 show a toolbox 10 for the storage of various tools according to the present invention. The toolbox 10 comprises a container 20 and a cover 30. The cover 30 is configured to selectively open and close the container 20. The container 20 comprises at least one hitch 24 on each of its lateral sides and at least one hitch 24 on its front side. The hitches 24 are configured to hitch with the cover 30 when the toolbox 10 is closed by the cover 30. In this embodiment, the container 20 comprises one hitch 24 on each of its lateral sides and two hitches 24 on its front side. As shown in the drawings, the cover 30 is pivotally connected to the container 20.

The container 20 is provided with a ratchet tool slot 21 that sequentially has a head section 211, a first wide section 212, and a first narrow section 213 along the first reference line B1. A width direction of the ratchet tool slot 21 is transverse to the first reference line B1. The head section 211 has a first width W1. The first wide section 212 is provided with two first wide section protrusions 214 each protruding from different sides of an inner periphery of the first wide section 212, and a distance between the two first wide section protrusions 214 has a second width W2, which is smaller than the first width W1. The first width W1 is greater than 2 times the second width W2 and less than 4 times the second width W2. The first narrow section 213 is provided with two first narrow section protrusions 215, each protruding from different sides of an inner periphery of the first narrow section 213, and a distance between the first narrow section protrusions 215 has a third width W3, which is smaller than the second width W2.

The container 20 is also provided with an extension rod slot 22. The extension rod slot 22 has a first end 221 and a second end 222 opposite to the first end 221 along an extension line E. A distance between the first and the second ends 221 and 222 is of a first length L1, which is transverse to a width direction of container 20. The container 20 has a width not greater than the first length L1. The extension rod slot 22 is provided with two first protrusions 223, each protruding from different sides of an inner periphery of the extension rod slot 22, and a distance from each of the two first protrusions 223 to the first end 221 is of a second length L2. Moreover, the extension rod slot 22 is provided with two second protrusions 224, each protruding from different sides of the inner periphery of the extension rod slot 22, and a distance from each of the two second protrusions 224 to the first end 221 is of a third length L3. Both the second and the third lengths L2 and L3 are not greater than 0.5 times the first length L1. The two first protrusions 223 are more adjacent to the first end 221 than the two second protrusions 224. The fifth length L5 is greater than 1.5 times the second length L2 and less than 3 times the second length L2. The extension rod slot 22 is further provided with two third protrusions 225, each protruding from different sides of the inner periphery of the extension rod slot 22, and a distance from each of the two third protrusions 225 to the second end 222 is of a fourth length L4. The fourth length L4 is not greater than 0.5 times the first length L1. The extension rod slot 22 is further provided with two fourth protrusions 226, each protruding from different sides of the inner periphery of the extension rod slot 22, and a distance from each of the two fourth protrusions 226 to the second end 222 is of a fifth length L5, which is smaller than the fourth length L4. The two fourth protrusions 226 are more adjacent to the second end 222 than the two third protrusions 225.

The container 20 is further provided with an F-rod slot 23 that sequentially has a second wide section 231 and a second narrow section 232 along a second reference line B2. The second reference line is parallel to the first reference line B1. The second wide section 231 is provided with two second wide section protrusions 233, each protruding from different sides of an inner periphery of the second wide section 231, and a distance between the two second wide section protrusions 233 is of a fourth width W4. The two second narrow section 232 is provided with two second narrow section protrusions 234, each protruding from different sides of an inner periphery of the second narrow section 232, and a distance between the two second narrow section protrusions 234 is of a fifth width W5, which is smaller than the fourth width W4. The F-rod slot 23 further has a side extension 235 that extends transversely to the second reference line B2. The side extension 235 is connected to and extends from the second wide section 231 and adjacent to an end opposite to an end that is connected to the second narrow section 232. The side extension 235 has a width WS not less than the fourth width W4.

Furthermore, the ratchet tool slot 21 is located between the extension rod slot 22 and the F-rod slot 23. The ratchet tool slot 21 includes the head section 211 adjacent to the second end 222 and the first narrow section 213 adjacent to the first end 221. The F-rod slot 23 includes the side extension 235 adjacent to the first end 221 and the second narrow section 232 adjacent to the second end 222.

Additionally, a width direction of the container 20 is transverse to the first length L1, and the container 20 has a width not greater than 0.5 times the first length L1. A height direction of the container 20 is transverse to both the width direction of the container 20 and the first length L1, and the container 20 has a height not greater than 0.5 times the first length L1. These relationships also apply to the cover 30. With this design, the toolbox 10 is easily portable and practical for accommodating tools of various sizes, whether they are short or long, big or small.

In view of the foregoing, the ratchet tool slot 21 can accommodate a ratchet wrench that has a handle with thick and thin sections and that can be fastened to an extension rod. Since the first width W1 is greater than twice the second width W2, the head section 211 is more practical for accommodating ratchet wrenches with various head sizes. Furthermore, the extension rod slot 22 can accommodate an extension rod, and the protrusions 223, 224, 225, and 226 used to fix the extension rod are offset from one end of the extension rod slot 22 so that the extension rod slot 22 is more practical for accommodating extension rods of various lengths. Additionally, the F-rod slot 23 can accommodate an F rod, especially an F rod that has a handle with thick and thin sections and can be connected to extension rods. Since the width WS is not less than the fourth width W4, the F-rod slot 23 is more practical for accommodating F rods of various sizes with square heads.

Although specific embodiments have been illustrated and described, numerous modifications and variations are still possible without departing from the scope of the invention. The scope of the invention is limited by the accompanying claims.

1. A toolbox for the storage of various tools comprising:
a container provided with a ratchet tool slot sequentially having a head section, a first wide section, and a first narrow section along the first reference line, wherein a width direction of the ratchet tool slot is transverse to the first reference line and the head section has a first width, wherein the first wide section is provided with two first wide section protrusions, each protruding from different sides of an inner periphery of the first wide section, and a distance between the two first wide section protrusions has a second width, which is smaller than the first width, and wherein the first narrow section is provided with two first narrow section protrusions, each protruding from different sides of an inner periphery of the first narrow section, and a distance between the first narrow section protrusions has a third width, which is smaller than the second width; and a cover configured to selectively open and close the container.

2. The toolbox as claimed in claim 1, wherein the first width is greater than 2 times the second width and less than 4 times the second width.

3. The toolbox as claimed in claim 1, wherein the container is provided with an extension rod slot, wherein the extension rod slot has a first end and a second end opposite to the first end along an extension line, and a distance between the first and the second ends is of a first length, wherein the extension rod slot is provided with two first protrusions, each protruding from different sides of an inner periphery of the extension rod slot, and a distance from each of the two first protrusions to the first end is of a second length, wherein the extension rod slot is provided with two second protrusions, each protruding from different sides of the inner periphery of the extension rod slot, and a distance from each of the two second protrusions to the first end is of a third length, and wherein both the second and the third lengths are not greater than 0.5 times the first length.

4. The toolbox as claimed in claim 3, wherein the two first protrusions are more adjacent to the first end than the two second protrusions, wherein the extension rod slot is provided with two third protrusions, each protruding from different sides of the inner periphery of the extension rod slot, and a distance from each of the two third protrusions to the second end is of a fourth length, wherein the fourth length is not greater than 0.5 times the first length, wherein the extension rod slot is provided with two fourth protrusions, each protruding from different sides of the inner periphery of the extension rod slot, and a distance from each of the two fourth protrusions to the second end is of a fifth length, which is smaller than the fourth length, and wherein the two fourth protrusions are more adjacent to the second end than the two third protrusions.

5. The toolbox as claimed in claim 4, wherein the fifth length is greater than 1.5 times the second length and less than 3 times the second length.

6. The toolbox as claimed in claim 3, wherein the container is provided with an F-rod slot sequentially having a second wide section and a second narrow section along a second reference line, wherein the second wide section is provided with two second wide section protrusions, each protruding from different sides of an inner periphery of the second wide section, and a distance between the two second wide section protrusions is of a fourth width, wherein the two second narrow section is provided with two second narrow section protrusions, each protruding from different sides of an inner periphery of the second narrow section, and a distance between the two second narrow section protrusions is of a fifth width, which is smaller than the fourth width, wherein the F-rod slot has a side extension extending transversely to the second reference line connected to and extending from the second wide section and adjacent to an end opposite to an end that is connected to the second narrow section, and wherein the side extension has a width not less than the fourth width.

7. The toolbox as claimed in claim 6, wherein the ratchet tool slot is located between the extension rod slot and the F-rod slot, wherein the ratchet tool slot includes the head section adjacent to the second end and the first narrow section adjacent to the first end, and wherein the F-rod slot includes the side extension adjacent to the first end and the second narrow section adjacent to the second end.

8. A toolbox for the storage of various tools comprising:
a container provided with an extension rod slot, wherein the extension rod slot has a first end and a second end opposite to the first end along an extension line, and a distance between the first and the second ends is of a first length, wherein the extension rod slot is provided with two first protrusions, each protruding from different sides of an inner periphery of the extension rod slot, and the distance from each of the two first protrusions to the first end is of a second length, wherein the inner periphery of the extension rod slot is provided with two second protrusions, each protruding from different sides of the inner periphery of the extension rod slot, and a distance from each of the two second protrusions to the first end is of a third length, and wherein both the second and the third lengths are not greater than 0.5 times the first length; and
a cover configured to selectively open and close the container.

9. The toolbox as claimed in claim 8, wherein the two first protrusions are more adjacent to the first end than the two second protrusions, wherein the extension rod slot is provided with two third protrusions, each protruding from different sides of the inner periphery of the extension rod slot, and a distance from each of the two third protrusions to the second end is of a fourth length, wherein the fourth length is not greater than 0.5 times the first length, wherein the extension rod slot is provided with two fourth protrusions, each protruding from different sides of the inner periphery of the extension rod slot, and a distance from each of the two fourth protrusions to the second end is of a fifth length), which is smaller than the fourth length, and wherein the two fourth protrusions are more adjacent to the second end than the two third protrusions.

10. The toolbox as claimed in claim 9, wherein the fifth length is greater than 1.5 times the second length and less than 3 times the second length.

11. The toolbox as claimed in claim 3, wherein a width direction of the container is transverse to the first length, and wherein the container has a width not greater than 0.5 times the first length.

12. The toolbox as claimed in claim 8, wherein a width direction of the container is transverse to the first length, and wherein the container has a width not greater than 0.5 times the first length.

13. The toolbox as claimed in claim 1, wherein the container has at least one hitch on each of its lateral sides and at least one hitch on its front side, and the hitches are configured to hitch with the cover when the toolbox is closed by the cover.

14. The toolbox as claimed in claim 8, wherein the container has at least one hitch on each of its lateral sides and at least one hitch on its front side, and the hitches are configured to hitch with the cover when the toolbox is closed by the cover.

15. The toolbox as claimed in claim 13, wherein the container comprises one hitch on each of its lateral sides and two hitches on its front side.

16. The toolbox as claimed in claim 14, wherein the container comprises one hitch on each of its lateral sides and two hitches on its front side.

17. The toolbox as claimed in claim 11, wherein a height direction of the container is transverse to both the width direction of the container and the first length, and wherein the container has a height not greater than 0.5 times the first length.

18. The toolbox as claimed in claim 12, wherein a height direction of the container is transverse to both the width direction of the container and the first length, and wherein the container has a height not greater than 0.5 times the first length.
